(19) United States
(12) Patent Application Publication
(10) Pub. No.: US 2024/0200872 A1
(43) Pub. Date: Jun. 20, 2024

(54) MELTING SYSTEM, AND PROCESS FOR MELTING ALUMINUM SCRAP

(71) Applicant: CONSTELLIUM NEUF-BRISACH SAS, Biesheim (FR)

(72) Inventors: Anne PICHAT, Saint Cassien (FR); Alain VASSEL, Saint Etienne de Crossey (FR)

(73) Assignee: CONSTELLIUM NEUF-BRISACH SAS, Biesheim (FR)

(21) Appl. No.: 18/542,943

(22) Filed: Dec. 18, 2023

(30) Foreign Application Priority Data
Dec. 16, 2022 (FR) 2213521

(51) Int. Cl. F27B 3/20; C22B 21/00; F23N 5/00; F27B 3/06; F27B 3/22; F27D 17/00

(52) U.S. Cl. CPC F27B 3/205; C22B 21/0092; F23N 5/003; F27B 3/065; F27B 3/225; F27D 17/001; F23N 2900/05001

(57) ABSTRACT

The invention relates to an aluminum scrap melting system (1) comprising a melting furnace (10) comprising a burner (20) which comprises an oxidant injector (23), and a fuel injector (25); a suction hood (30) intended to capture by suction the combustion fumes (F) and comprising a carbon monoxide sensor (37) configured to measure a carbon monoxide concentration (C) in said combustion fumes (F); and a control device (50) configured to receive an item of input information representative of the value of the carbon monoxide concentration (C), and to pilot the oxidant injector (23) and/or the fuel injector (25), according to said item of input information, the oxidant and fuel flows being piloted to contain the volatile organic compound content (VOC) at the output of the melting furnace at concentrations less than a safety value. The invention also relates to a process for melting aluminum scrap with such a melting system (1).

### TECHNICAL FIELD OF THE INVENTION

The present invention relates to the field of aluminum scrap recycling and more particularly, the field of aluminum scrap melting systems for melting aluminum scrap.

The present invention also relates to the field of processes for melting aluminum scrap with an aluminum scrap melting system.

### PRIOR ART

In the field of aluminum scrap recycling, it is known to use rotary furnaces, or tilting rotary furnaces. This technology is specifically designed to treat oxidized scrap, such as foundry dross, or materials containing organic coatings such as in particular coated coils, manufacturing scrap, or materials consisting of small individual particles, such as used beverage cans, or UBCs. Prior to their introduction into the rotary furnace, used beverage cans are generally compacted to form a load having an overall parallelepipedal or cubic shape. Given that used beverage cans are coated with varnish and paint, organic residues are systematically found in these loads. The residual carbon content in each load is therefore very variable and depends on the quantity of varnish and paint present on the crushed used beverage cans in the load and the process piloting conditions.

When melting aluminum scrap, apart from liquid aluminum which is intended to be recovered and cast, oxides are also formed which are impurities present in the molten mass. To remove these oxides, it is known in the prior art to use salts which make it possible on one hand to limit aluminum oxidation, but also to separate these oxides from the molten mass by forming a slag on the surface of the molten metal.

To remove organic coatings, different methods can be used. A first method as described in the document US2017/0051914A1 consists of evaporating the organic coatings by heating, and then carrying out a post-combustion in a separate chamber before melting the metal in a second furnace.

Alternatively, and as described in the documents WO2005/085732A1, and EP1243663A2, it is possible to remove the organic coatings by delacquering the used beverage cans by combustion directly in the furnace used for melting the metal. During such an operation, the stoichiometry used by the oxidant and the fuel is decisive as it influences the composition of the combustion fumes produced, and the quality of the liquid metal obtained. If the quantity of oxidant is not sufficient, the combustion is incomplete, and forms volatile organic compounds (VOCs), rather than carbon dioxide.

The document EP4092390 describes an apparatus capable of monitoring and adjusting a combustion condition in a furnace in real time, comprising: a furnace having a heating chamber, a combustion chamber, a loading door, an exhaust gas flow opening, and an exhaust gas flow pipe and sensors of the same type disposed at different positions in the exhaust gas flow pipe and a control device receiving signals from the two sensors and adjusting, according to a difference between the signals, the quantity of oxidant and/or gas containing oxygen entering the combustion chamber.

The document US2005/103159 describes a process for melting aluminum, which consists of introducing solid aluminum into a furnace, melting the aluminum to form an aluminum bath, detecting carbon monoxide (CO) and/or hydrogen (H2) concentration variations and the temperature of the fumes coming out of the furnace, by deducing the aluminum oxide formation on the surface of the aluminum bath by controlling the melting process according to the aluminum oxide formation.

The document WO 01/33200 relates to processes and apparatuses using tunable diode lasers for monitoring and/or checking a high-temperature process using an oxidant containing O2 and an organic fuel.

The document US2020/284513 relates to a process for controlling a combustion in a furnace heated by a burner equipped with at least one oxygen lance, wherein a fuel is conveyed via a burner fuel supply and oxygen is supplied at least partially with a high speed of 100 m/s or more via the oxygen lance(s), and oxygen in superstoichiometric range is supplied.

The document DE102013012831 relates to a process for melting contaminated aluminum in a rotary drum furnace. The rotary drum furnace is heated by means of a burner, the burner being fired with a gaseous mixture of fuel, oxygen and air, the burner being fired with the gaseous mixture in a ratio of mixture of fuel, oxygen and air such that the burner is fired in a superstoichiometric combustion ratio with a lambda value greater than 1.

The document US2011/154949 relates to a process for operating a furnace, wherein a raw material comprising at least one metallic element is melted, the raw material being heated by at least one burner which operates with a volume flow rate of fuel and a volume flow rate of an oxidant.

The document WO2021/220802 relates to a melting/refining furnace for sources of cold iron and a process for operating a melting/refining furnace, whereby it becomes possible to enhance the heating efficiency of a raw material and reduce the quality of electrical energy required to melt the raw material without triggering the oxidation of the raw material, and reduce a melting/refining time, and enhance the productivity and reduce costs.

Volatile organic compounds refer to any organic molecules containing at least one carbon atom associated with hydrogen, nitrogen, oxygen, sulfur, chloride, etc., except for carbon monoxide CO, carbon dioxide CO2, water H2O, and nitrogen oxides NOx. A first problem posed by VOC formation is that it contributes to lowering the temperature prevailing inside the furnace chamber. A second problem stems from the fact that some VOCs are toxic. It is therefore essential to limit their formation, or drastically lower their concentration before the combustion fumes are evacuated from the melting system. Moreover, most industrial processes are subject to the regulatory requirements governing VOC emission thresholds.

However, if the conditions are highly oxidizing (i.e., with a quantity of oxidant greater than the quantity of fuel), all the organic material is burned to form carbon dioxide, but it is possible to oxidize liquid aluminum, and therefore generate oxides. A consequence of this oxide generation is that they can be incorporated in the molten metal, which degrades the quality of the metal obtained after solidification. In the document WO2005/085732A1, a phase of reducing the oxidation of liquid aluminum is thus provided to prevent oxide formation. However, such a reduction phase has the disadvantage of increasing the quantity of fuel released (for example methane), which is a volatile organic compound.

It is therefore clearly understood that, given that the carbon content in each load is very variable, it is very difficult to check the maximum quantity of load to introduce into the furnace to ensure both optimal combustion and melting of the metal having a good yield, while limiting VOC emissions outside the melting system. Moreover, given that the oxidant flow is technically limited by the capacities of the furnace, it is sometimes possible to supply enough oxidant to prevent an incomplete combustion, in particular if the carbon content in the load is too high.

Moreover, in melting devices as described in the document WO2005/085732A1, the combustion fumes produced are introduced into a pipe to be cooled. This cooling mode generally implies the formation of toxic dioxin which should be prevented.

### SUBJECT MATTER OF THE INVENTION

The aim of the present invention is that of providing a solution which addresses all or some of the problems cited above. In particular, the melting system according to the invention is aimed at:
limiting VOC formation;
limiting dioxin formation;
melting aluminum and combusting organic coatings inside the same furnace, while limiting oxide formation;
melting an optimal quantity of aluminum scrap in a large-sized furnace.

This aim can be achieved thanks to the implementation of an aluminum scrap melting system for melting aluminum scrap, the melting system comprising:
a melting furnace intended to melt said aluminum scrap, and comprising:
a drum internally delimiting a melting chamber intended to receive said aluminum scrap to be melted;
a burner comprising a firing device, at least one oxidant injector, and at least one fuel injector, said oxidant injector being configured to inject an oxidant flow inside the melting chamber, said fuel injector being configured to inject a fuel flow inside the melting chamber, and the firing device being configured to start a combustion of the oxidant and the fuel injected into the melting chamber, to supply heat into the melting chamber;
evacuation means configured to make it possible to extract all or some of the combustion fumes from inside the melting chamber to a vent zone located outside the melting chamber and where air is free to circulate;
a suction hood disposed outside the melting chamber and intended to capture by suction all or some of said combustion fumes present in the vent zone, said suction hood furthermore comprising an inspection pipe comprising a carbon monoxide sensor configured to measure a value of a carbon monoxide concentration in said combustion fumes captured by the suction hood, the carbon monoxide sensor comprising a laser emitter configured to emit a laser radiation, and a laser receiver configured to receive said emitted laser radiation, and to measure an absorption spectrum of said received laser radiation, the value of the carbon monoxide concentration (C) being determined on the basis of said absorption spectrum thus measured;
a control device configured to receive an item of input information representative of the value of the carbon monoxide concentration measured by the carbon monoxide sensor, and to pilot said oxidant flow injected by said oxidant injector and/or said fuel flow injected by said fuel injector, according to said item of input information, the oxidant and fuel flows being piloted to contain the VOC content at the output of the melting furnace at concentrations less than a safety value.

The arrangements described above make it possible to provide an aluminum scrap melting system capable of melting the aluminum scrap to obtain liquid aluminum, while making it possible to burn the volatile organic compounds inside the melting chamber. The presence of the carbon monoxide sensor communicating with the control device furthermore makes it possible to pilot the oxidant and fuel flows to contain the VOC content at the output of the melting furnace at concentrations less than a safety value.

Advantageously, the use of a suction hood at the evaluation means of the melting furnace makes it possible to rapidly cool the combustion fumes by mixing the fumes with the free air directly at the output of the furnace, while capturing said combustion fumes. In this way, it is possible to limit dioxin formation in the combustion fumes, while ensuring the capture of all the cooled combustion fumes at the output of the melting furnace.

The melting system can furthermore have one or more of the following features, taken alone or in combination.

According to an embodiment, the melting furnace comprises a material introduction door configured to allow the introduction of the aluminum scrap inside the melting chamber. In this case, the material introduction door is opened to introduce the aluminum scrap inside the melting chamber.

The term “pilot” means that the control device is capable of controlling or varying the oxidant and/or fuel flows introduced into the furnace chamber, for example via one or more valves.

According to an embodiment, the control device is a programmable controlled configured to automatically pilot the oxidant flow injected by the oxidant injector, and/or the fuel flow injected by the fuel injector, and/or optionally the rotational speed of the rotary drum, for example according to an algorithm saved in a memory of the control device. Such an algorithm optionally comprising instructions corresponding to operating modes of a step of piloting the melting process according to the invention.

According to an embodiment, the melting furnace is a rotary furnace comprising a rotary drum configured to be rotated.

In this way, it is possible to accelerate or slow down the combustion of the organic coatings by rotating the rotary drum.

According to a further embodiment, the melting furnace is a multi-chamber furnace.

According to an embodiment, the evacuation means of the melting furnace comprise at least one opening arranged in a wall of the melting furnace.

According to an embodiment, the at least one opening is disposed at a door of the melting furnace, for example on an upper portion of said door.

The arrangements described above make it possible to provide a door which is not tight to the combustion fumes. The design and the manufacture of such a door is therefore facilitated with respect to aluminum scrap melting systems wherein the door is tight. It is thus possible to design and manufacture large-sized rotary melting furnaces capable of receiving a larger quantity of aluminum scrap.

Advantageously, the presence of the suction hood makes it possible furthermore to prevent combustion fumes from leaking outside the aluminum scrap melting system, and therefore limit diffusions in the workshop wherein the melting furnace is located.

The carbon monoxide sensor comprises a laser emitter configured to emit a laser radiation, and a laser receiver configured to receive said emitted laser radiation, and to measure an absorption spectrum of said received laser radiation, the value of the carbon monoxide concentration being determined based on said absorption spectrum thus measured.

In other words, the carbon monoxide sensor measures the value of the carbon monoxide concentration by a laser absorption spectrometry measurement method, also referred in the terminology to as tunable diode laser absorption spectroscopy (TDLAS).

Advantageously, the use of a laser absorption spectrometry measurement method by the carbon monoxide sensor makes it possible to measure a carbon monoxide concentration value with a sensitivity of the order of 0.3 ppm within a time interval less than 1 second. This is particularly advantageous to perform quasi-real time piloting of the melting furnace to check the combustion of the volatile organic compounds.

Moreover, such a carbon monoxide sensor has the advantage of being a contactless measuring means, facilitating maintenance.

Finally, this inline spectrometry measurement method makes it possible to limit the interference with other gases, which renders the measurement reliable.

According to an embodiment, the melting furnace comprises an additional oxidant lance distinct from the at least one oxidant injector, and configured to allow the introduction of an additional oxidant flow inside the melting chamber.

According to an embodiment, the additional oxidant lance has a maximum oxidant introduction flow into the melting chamber which is strictly greater than a maximum oxidant introduction flow from the at least one oxidant injector.

The arrangements described above make it possible to provide a melting furnace having enhanced oxidant injection capacities, which is particularly adapted to enhance the combustion of the volatile organic compounds inside the melting chamber.

According to an embodiment, the oxidant injector is an industrially pure oxygen injector.

According to an embodiment, the additional oxidant lance is an industrially pure oxygen lance.

In this way, it is possible to enhance the combustion of the volatile organic compounds, without cooling the inside of the melting furnace. This is particularly advantageous to reduce the time and therefore the necessary energy to be supplied to melt a given quantity of aluminum scrap with respect to a melting furnace using an oxidant comprising a quantity of dioxygen strictly less than 100%, typically air or oxygen-enriched air.

According to an embodiment, the inspection pipe of the suction hood comprises a suction end at which the combustion fumes are captured, and a filtration end, opposite the suction end, said filtration end being equipped with a dust filter configured to filter combustion products distinct from the VOCs remaining in the combustion fumes, at the filtration end. Advantageously, the dust filter can be a lime filter configured both to capture the dust remaining the combustion fumes, and to neutralize acid fumes such as hydrochloric acid (HCl).

In this way, it is possible to filter the combustion fumes before they escape outside the aluminum scrap melting system.

According to an embodiment, the melting system comprises a carbon dioxide trap disposed at the filtration end, said carbon dioxide trap being configured to trap all or some of the carbon dioxide present in the combustion fumes prior to their evacuation out of the melting system.

The aim of the invention can also be achieved thanks to the implementation of a process for melting aluminum scrap with an aluminum scrap melting system, the melting process comprising:
a step of providing an aluminum scrap melting system as described above;
a first introduction step wherein a first quantity of said aluminum scrap is introduced into the melting chamber of the melting furnace;
a melting step wherein the firing device is fired so that the burner supplies heat into the melting chamber of the melting furnace when it is supplied with oxidant and with fuel respectively by the oxidant injector, and by the fuel injector, said melting step resulting in the formation of liquid aluminum by melting, and in the formation of combustion fumes;
a measurement step wherein the carbon monoxide sensor measures the value of the carbon monoxide concentration in the combustion fumes captured by the suction hood;
a piloting step wherein the control device receives an item of input information representative of the value of the carbon monoxide concentration measured by the carbon monoxide sensors, and pilots the oxidant flow injected by the oxidant injector, and/or pilots the fuel flow injected by the fuel injector, according to said item of input information
the process furthermore comprising a prior calibration step (E11), wherein a correlation law is established between:
a mean carbon monoxide concentration (Cm) measured by the carbon monoxide sensor (37), and
a mean volatile organic compound concentration (VOC) measured at the filtration end (35) by a volatile organic compound sensor (VOC),
said correlation law being established on the basis of at least three mean carbon monoxide concentration values (Cm) measured by the carbon monoxide sensor (37), each associated with a mean volatile organic compound concentration value ([VOC]m) measured over the same time interval.
wherein the oxidant and fuel flows are piloted to contain the volatile organic compound content (VOC) at the output of the melting furnace at concentrations less than a safety value.

In an advantageous embodiment, the oxidant flow injected by the oxidant injector, and/or pilots the fuel flow injected by the fuel injector are adjusted to maintain an oxidation stoichiometry for the gas injection.

The arrangements described above make it possible to provide a melting process making it possible both to form liquid aluminum from aluminum scrap and limit the quantity of volatile organic compounds in the combustion fumes evacuated outside the melting chamber of the melting furnace by the thermolysis of said volatile organic compounds in-situ in the melting furnace.

The melting process can furthermore have one or more of the following features, taken alone or in combination.

According to an embodiment, the first introduction step furthermore comprises the introduction of at least one salt, so as to obtain a slag referenced “L” covering the liquid aluminum and comprising alumina and said at least one salt during the melting step.

Advantageously, the introduction of at least one salt during the first introduction step makes it possible to trap solid residual organic compounds which are obtained from the thermolysis of the organic materials present in the aluminum scrap.

According to an embodiment, the melting process comprises a step of draining the melting furnace, wherein all of some of the liquid aluminum contained in the melting chamber is extracted from the melting chamber, typically by tilting or siphoning.

According to an embodiment, during the piloting step, the control device pilots the oxidant flow injected by the oxidant injector, and/or the fuel flow injected by the fuel injector according to the following operating modes:
a first operating mode wherein the oxidant flow and the fuel flow are chosen to introduce the oxidant and the fuel into the melting chamber in stoichiometric proportions, the first operating mode being established if the value of the carbon monoxide concentration is strictly less than a first threshold;
a second operating mode wherein a ratio between the oxidant flow and the fuel flow is varied between an initial ratio corresponding to an introduction under stoichiometric conditions of oxidant and fuel into the melting chamber respectively by the oxidant injector and the fuel injector, and a maximum ratio corresponding to a zero fuel flow introduced by the fuel injector into the melting chamber and a maximum oxidant flow introduced by the oxidant injector into the melting chamber, said ratio between the oxidant flow and the fuel flow being varied according to the value of the carbon monoxide concentration measured, the second operating mode being established if the value of the carbon monoxide concentration is strictly less than a second threshold and greater than or equal to the first threshold;
a third operating mode wherein the oxidant flow is placed at the maximum oxidant flow value, the fuel flow is stopped, and the firing device is switched off, the third operating mode being established if the value of the carbon monoxide concentration is strictly less than a third threshold and greater than or equal to the second threshold;
a fourth operating mode wherein the oxidant flow is placed at a maximum flow value, the fuel flow is stopped, the firing device is switched off, the fourth operating mode being established if the value of the carbon monoxide concentration is strictly greater than the third threshold, said thresholds being determined to limit the volatile organic compound VOC emissions less than defined thresholds.

According to an embodiment, if the melting furnace is a rotary furnace comprising a rotary drum, the fourth operating mode furthermore comprises the variation, and in particular the reduction of the rotational speed of the rotary drum.

According to an embodiment, the first threshold is strictly less than the second threshold.

According to an embodiment, the second threshold is substantially equal to five times the value of the first threshold.

According to an embodiment, the second threshold is strictly less than the third threshold.

According to an embodiment, the third threshold is substantially equal to two times the value of the second threshold.

According to an embodiment, the first threshold is substantially equal to 30 ppm.

According to an embodiment, the second threshold is substantially equal to 150 ppm. According to an embodiment, the third threshold is substantially equal to 300 ppm.

The term “substantially equal” means “within more or less 10%”.

Advantageously, the piloting of the oxidant and fuel injectors makes it possible both to limit the formation of volatile organic compounds, but also to prevent overoxidation risks. Indeed, if the oxidant and fuel injectors are placed in the second, third and fourth operating mode, the excess oxidant is consumed to limit volatile organic compound formation, and does not oxidize the liquid aluminum. Moreover, and advantageously, if the melting process comprises the introduction of at least one salt, the slag formed acts as a screen against the oxidation of the liquid aluminum by the injected oxidant.

According to an embodiment, the fourth operating mode furthermore comprises the introduction of an additional fuel flow inside the melting chamber by the additional lance.

In this way, it is possible to increase the quantity of oxidant introduced into the melting chamber, and destroy by combustion a greater quantity of volatile organic compounds without lowering the melting temperature of the melting furnace.

According to an embodiment, the first operating mode comprises the implementation of a second introduction step wherein a second quantity of aluminum scrap is introduced into the melting chamber of the melting furnace. For example, it can be provided that the second introduction step be implemented when the control device pilots the oxidant flow and the fuel flow in the first operating mode directly after having piloted the oxidant flow and the fuel flow in an operating mode chosen from the second, third, or fourth operating mode.

Thus, it is possible to adapt the quantity of aluminum scrap introduced into the melting chamber, without previously measuring the quantity of volatile organic compounds in the aluminum scrap. The liquid aluminum melting yield is thus increased.

According to an embodiment, during the piloting step, if the firing device is switched off, and if the value of the carbon monoxide concentration is strictly less than a restart threshold value, then the firing device is switched on, the restart threshold value being strictly greater than the first threshold and strictly less than the second threshold. For example, the restart threshold value is substantially equal to 1.5 times the value of the first threshold.

According to an embodiment, the restart threshold value is substantially equal to 45 ppm.

Advantageously, refiring the firing device once the carbon monoxide concentration is less than a sufficiently low threshold makes it possible to restart melting of the aluminum, and limit oxide formation on the surface of the liquid aluminum. This arrangement makes it possible to account for any hysteresis phenomena during the melting of the metal and the combustion of the organic coatings, which are linked with the inertia of the melting furnace.

The melting process comprises a prior calibration step, wherein a correlation law is established between:
a mean carbon monoxide concentration measured by the carbon monoxide sensor, and
a mean volatile organic compound concentration measured at the filtration end by a volatile organic compound sensor,
   said correlation law being established on the basis of at least three mean carbon monoxide concentration values measured by the carbon monoxide sensor, each associated with a mean volatile organic compound concentration value measured over the same time interval. According to an embodiment, the correlation law is in the form of a linear equation, and is established by a linear regression method. Indeed, the applicant surprisingly observed that it was possible to establish a linear relationship between the mean carbon monoxide concentration at the output of the melting furnace, and the mean VOC concentration at the filtration end. This correlation law being in particular dependent on the melting system used, because it is dependent in particular on the melting furnace, the suction hood and the dilution rate of the combustion fumes in the free air prior to their capture by the suction hood.

According to an embodiment, the mean volatile organic compound concentration measured at the filtration end by a volatile organic compound sensor, is measured downstream from the dust filter, i.e., after the dust filter has filtered the combustion fumes.

For example, the time interval corresponds to a melting cycle corresponding to the time interval elapsing between the introduction of the first quantity of aluminum scrap, and the step of draining the liquid aluminum. During this melting cycle, a mean carbon monoxide concentration value is measured by calculating an arithmetic mean of the carbon monoxide concentration values measured by the carbon monoxide sensor over said melting cycle. Over the same melting cycle, a mean VOC concentration value is measured by calculating an arithmetic mean of the VOC concentration values measured by the VOC sensor. This mean VOC concentration is then associated with the mean carbon monoxide concentration value. This operation is repeated at least three times to obtain at least three pairs of mean carbon monoxide and VOC concentration values, making it possible to establish a linear equation in the form [COV]ₘ=α×Cm where [VOC]ₘ is the mean VOC concentration measured over a cycle expressed in milligrams of carbon equivalent per normal cubic meter (mg/Nm³), Cm is the mean carbon monoxide concentration measured over a cycle expressed in ppm, and α is a positive real coefficient. For example, the coefficient α is substantially equal to 0.4.

The restart threshold value, the first threshold, the second threshold, and the third threshold are determined following the calibration step. Said thresholds are determined to limit the volatile organic compound emissions lower than defined thresholds, for example by use, or by normative requirements.

For example, the first threshold can correspond to the following formula:

$$S 1 = {\frac{2}{5 α} [ VOC ]}_{max}$$

the second threshold can correspond to the following formula:

$$S 2 = {\frac{2}{α} [ VOC ]}_{max}$$

the third threshold can correspond to the following formula:

$$S 3 = {\frac{4}{α} [ VOC ]}_{max}$$

the restart threshold value can correspond to the following formula:

$$S r = {\frac{3}{5 α} [ VOC ]}_{max}$$

where α is the coefficient determined by establishing the linear equation described above, and
where [VOC]ₘₐₓ is a maximum mean VOC concentration value over a melting cycle, fixed arbitrarily by the user, or by regulatory or normative requirements.

According to an embodiment, the melting process furthermore comprises a cooling step, wherein the combustion fumes are diluted and cooled in the free air outside the melting chamber. It is clearly understood that over a melting cycle, the cooling step and the measurement step can be implemented simultaneously and continuously.

The arrangements described above make it possible to cool the combustion fumes outside the melting chamber in the free air. This cooling step is particularly advantageous because it makes it possible to dilute and cool the combustion fumes while minimizing toxic dioxin formation.

For example, the cooling step comprises an evacuation step wherein the evacuation means are actuated to allow the evacuation of the combustion fumes produced during the melting step outside the melting chamber and the free air, and a suction step wherein the suction hood captures by suction the combustion fumes present in the free air outside the melting furnace.

According to an embodiment, the piloting step is carried out after the measurement step within the same phase and said phase is repeated over time, in particular cyclically or periodically.

According to an embodiment, the measurement step is implemented several times over a piloting time interval, so as to implement the piloting step several times over said piloting time interval.

According to an embodiment, the measurement step and the piloting step are implemented continuously and in real time over the piloting interval. Thus, it is possible to pilot the melting furnace in real time during the piloting process. In this way, it is possible to optimize the melting time of the quantity of aluminum scrap, while limiting the quantity of volatile organic compounds evacuated outside the melting chamber.

### BRIEF DESCRIPTION OF THE DRAWINGS

Further aspects, advantages and features of the invention will become more apparent on reading the following description of preferred embodiments thereof, given by way of non-limiting example, with reference to the appended drawings wherein:

FIG. 1 is a schematic view of a melting system according to a particular embodiment of the invention.

FIG. 2 is a schematic view of a melting process according to a particular embodiment of the invention.

### DETAILED DESCRIPTION OF THE INVENTION

In the figures and hereinafter in the description, the same references represent identical or similar elements. Furthermore, the different elements are not represented to scale so as to favor the clarity of the figures. Moreover, the various embodiments and variants are not mutually exclusive and can be combined with each other.

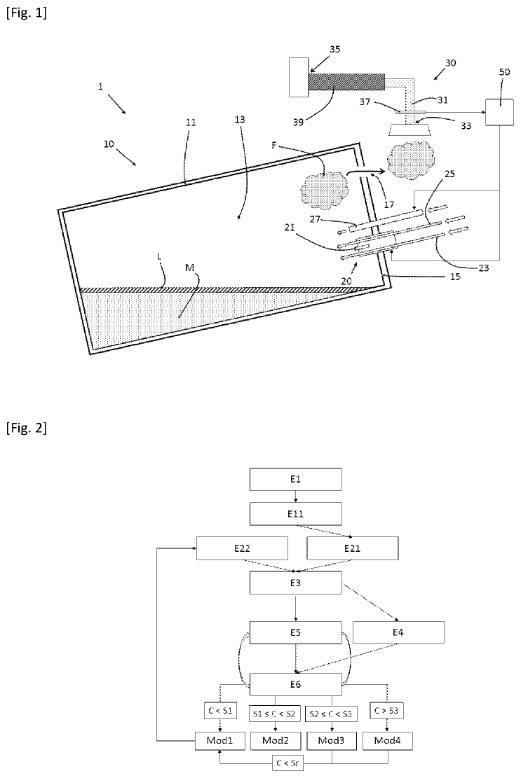

As illustrated in FIG. 1, the invention relates to an aluminum scrap melting system 1 for melting aluminum scrap. Such aluminum scrap can for example correspond to used beverage cans that have been compacted together so as to form a mass of scrap to be melted.

The melting system 1 firstly comprises a melting furnace 10 intended to melt said aluminum scrap. According to a first variant, the melting furnace 10 is a rotary furnace, but such a variant is not restrictive and it is also possible that the melting furnace 10 be a multi-chamber furnace, or any other furnace capable of melting aluminum, i.e., capable of placing a mass of scrap at a temperature greater than 660° C.

The melting furnace 10 comprises a drum 11 internally delimiting a melting chamber 13 intended to receive the aluminum scrap to be melted. According to the variant described above wherein the melting furnace 10 is a rotary furnace, the drum 11 is a rotary drum 11 configured to be rotated. In this way, it is possible to accelerate or slow down the combustion of the organic coatings by rotating the rotary drum 11.

The melting furnace 10 also comprises a burner 20 comprising a firing device 21, at least one oxidant injector 23, and at least one fuel injector 25.

The oxidant injector 23 is configured to inject an oxidant flow inside the melting chamber 13. It is generally coupled with an oxidant supply disposed outside the melting furnace 10, as well as with an oxidant valve for varying the oxidant flow injected inside the melting chamber 13. Such an oxidant valve can advantageously be actuated automatically, so as to be able to pilot or vary automatically the oxidant flow inserted inside the combustion chamber 13. According to an embodiment, the burner 20 comprises a central oxidant injector 23 disposed in the vicinity of the firing device 21, as well as 4 peripheral oxidant injectors 23 disposed at equal distance from the central oxidant injector 23. However, such an architecture is not restrictive, and the burner 20 can comprise one or more oxidant injectors 23 arranged in another manner.

Advantageously, the oxidant injector 23 can be an industrially pure oxygen injector. In this way, it is possible to enhance the combustion of the volatile organic compounds VOC, without cooling the inside of the melting furnace 10. This is particularly advantageous to reduce the time and therefore the necessary energy to be supplied to melt a given quantity of aluminum scrap with respect to a melting furnace 10 using an oxidant comprising a quantity of dioxygen strictly less than 100%, typically air or oxygen-enriched air.

The fuel injector 25 is configured at its end to inject a fuel flow inside the melting chamber 13. It is generally coupled with a fuel supply disposed outside the melting furnace 10, as well as with a fuel valve for varying the fuel flow injected inside the melting chamber 13. Such a fuel valve can also be actuated automatically, so as to be able to pilot or automatically vary the fuel flow inserted inside the combustion chamber 13. According to an embodiment, the burner 20 can comprise a single fuel injector 25 disposed in the vicinity of the central oxidant injector 23 and the firing device 21.

The firing device 21 is configured to start a combustion of the oxidant and the fuel injected into the melting chamber 13, in order to supply heat in the melting chamber 13. Thus, the burner 20 is capable of enabling melting of the aluminum scrap in the melting chamber 13. Moreover, the melting furnace 10 enables the combustion of the organic compounds present in the aluminum scrap.

As illustrated in FIG. 1, the melting furnace 10 can also comprise an additional oxidant lance 27 distinct from the at least one oxidant injector 23, and configured to allow the introduction of an additional oxidant flow inside the melting chamber 13. This additional oxidant lance 27 is not generally comprised in the burner 20. It can for example have a maximum oxidant introduction flow into the melting chamber 13 which is strictly greater than a maximum oxidant introduction flow from the at least one oxidant injector 23. In the same way as for the oxidant injector 23, the additional oxidant lance 27 can be an industrially pure oxygen lance. The arrangements described above make it possible to provide a melting furnace 10 having enhanced oxidant injection capacities, which is particularly adapted to enhance the combustion of the volatile organic compounds VOC inside the melting chamber 13.

The melting furnace 10 finally comprises evacuation means 17 configured to make it possible to extract all or some of the combustion fumes referenced “F” from inside the melting chamber 13 to a vent zone located outside the melting chamber 13 and where air is free to circulate. As illustrated in FIG. 1, the melting furnace 10 can comprise a material introduction door 15 configured to allow the introduction of the aluminum scrap inside the melting chamber 13, when this door 15 is open. For example, the evacuation means 17 of the melting furnace 10 can consist of at least one opening arranged in a wall of the melting furnace 10, for example at the door 15 of the melting furnace 10 which serves to introduce material. In FIG. 1, the evacuation means 17 comprise a single opening disposed on an upper portion of the door 15, it is nonetheless clearly understood that the evacuation means 17 can also comprise several openings. The arrangements described above make it possible to provide a door 15 which is not tight to combustion fumes F. The design and the manufacture of such a door 15 is therefore facilitated with respect to aluminum scrap melting systems wherein the door 15 is tight. It is thus possible to design and manufacture large-sized rotary melting furnaces 10 capable of receiving a larger quantity of aluminum scrap.

The aluminum scrap melting system 1 furthermore comprises a suction hood 30 disposed outside the melting chamber 13 and intended to capture by suction all or some of the combustion fumes F present in the vent zone. The suction hood 30 comprises an inspection pipe 31 which can comprise a suction end 33 at which the combustion fumes Fare captured. For example, this suction end 33 can be disposed at the evacuation means 17 of the melting furnace 10. In this way, it is possible to rapidly cool the combustion fumes F by mixing them with the free air directly at the output of the furnace, while capturing said combustion fumes F. The formation of dioxin by de novo synthesis in the combustion fumes F is therefore limited, and the combustion fumes F are cooled and captured directly at the output of the melting furnace 10. In other words, the presence of the suction hood 30 makes it possible to prevent combustion fumes F from leaking outside the aluminum scrap melting system 1 and therefore limit diffusions in the workshop wherein the melting furnace 10 is located.

The inspection pipe 31 of the suction hood 30 can also comprise a filtration end 35 opposite the suction end 33. This filtration end 35 can advantageously be equipped with a dust filter 39 configured to filter combustion products separate from the VOCs remaining the combustion fumes F, at the filtration end 35. Advantageously, the dust filter 39 can be a lime filter configured both to capture the dust remaining the combustion fumes, and to neutralize acid fumes such as hydrochloric acid (HCl). In this way, it is possible to filter the combustion fumes F before they escape outside the aluminum scrap melting system 1. According to a variant not shown, the melting system 1 comprises a carbon dioxide trap disposed at the filtration end 35, said carbon dioxide trap being configured to trap all or some of the carbon dioxide present in the combustion fumes F prior to their evacuation out of the melting system 1.

The inspection pipe 31 comprises a carbon monoxide sensor 37 configured to measure a value of a carbon monoxide concentration referenced “C” in said combustion fumes F captured by the suction hood 30. The carbon monoxide sensor 37 comprises a laser emitter configured to emit a laser radiation, and a laser receiver configured to receive said emitted laser radiation, and to measure an absorption spectrum of said received laser radiation, the value of the carbon monoxide concentration C being determined based on said absorption spectrum thus measured. In other words, the carbon monoxide sensor 37 measures the value of the carbon monoxide concentration C by a laser absorption spectrometry measurement method, also referred in the terminology to as tunable diode laser absorption spectroscopy (TDLAS). Advantageously, the use of a laser absorption spectrometry measurement method by the carbon monoxide sensor 37 makes it possible to measure a carbon monoxide concentration C value with a sensitivity of the other of 0.3 ppm within a time interval less than 1 second. This is particularly advantageous to perform quasi-real time piloting of the melting furnace 10 to check the combustion of the volatile organic compounds. Moreover, such a carbon monoxide sensor 37 has the advantage of being a contactless measuring means, facilitating maintenance. Finally, this inline spectrometry measurement method makes it possible to limit the interference with other gases, which renders the measurement reliable.

Finally, the aluminum scrap melting system 1 comprises a control device 50 configured to receive an item of input information representative of the value of the carbon monoxide concentration C measured by the carbon monoxide sensor 37, and to pilot the oxidant flow injected by said oxidant injector 23 and/or the fuel flow injected by said fuel injector 25, according to said item of input information, the oxidant and fuel flows being piloted to contain the VOC content at the output of the melting furnace at concentrations less than a safety value. The term “pilot” means that the control device 50 is capable of controlling or varying the oxidant and/or fuel flows introduced into the furnace chamber, for example via one or more valves. As a general rule, the control device 50 is a programmable controller configured to automatically pilot the oxidant flow injected by the oxidant injector 23 and/or the fuel flow injected by the fuel injector 25, and/or optionally the rotational speed of the rotary drum 11, for example according to algorithm saved in a memory of the control device 50. Such an algorithm optionally comprising instructions corresponding to operating modes of a step E6 of piloting the melting process which will be described hereinafter.

The arrangements described above make it possible to provide an aluminum scrap melting system 1 capable of melting the aluminum scrap to obtain liquid aluminum referenced “M”, while making it possible to burn the volatile organic compounds VOC inside the melting chamber 13. The presence of the carbon monoxide sensor 37 communicating with the control device 50 makes it possible to pilot the oxidant and fuel flows to contain the VOC content at the output of the melting furnace 10 at concentrations less than a safety value.

The invention also relates to a process for melting aluminum scrap with an aluminum scrap melting system 1. Following the melting process, the implementation of a step of draining the melting furnace 10 (not shown), wherein all of some of the liquid aluminum M contained in the melting chamber is extracted from the melting chamber 13, typically by tilting or siphoning, is generally provided.

An embodiment of the melting process is for example shown in FIG. 2. The melting process firstly comprises a step E1 of providing an aluminum scrap melting system 1 of the type of one of those described above.

Prior to the implementation of other steps of the melting process, a calibration step E11 is carried out, wherein the piloting parameters of the melting furnace 10 are determined. As we will see hereinafter, these piloting parameters can be used during a piloting step E6 which is then implemented differently according to said piloting parameters of the furnace, i.e., according to the type of melting furnace 10 used, or according to the size of this melting furnace 10. During the calibration step E11, a correlation law, for example in the form of a linear equation, is established between:
a mean carbon monoxide concentration Cm measured by the carbon monoxide sensor 37, and
a mean volatile organic compound concentration [VOC]ₘ measured at the filtration end 35 by a volatile organic compound sensor VOC.

For example, such a correlation law is established by a linear regression method on the basis of at least three mean carbon monoxide concentration values Cm determined based on the measurements of the carbon monoxide sensor 37, each associated with a mean volatile organic compound concentration value [VOC]ₘ determined over the same time interval. Indeed, the applicant surprisingly observed that it was possible to establish a linear relationship between the mean carbon monoxide concentration Cm at the output of the melting furnace 10, and the mean VOC concentration [VOC]ₘ at the filtration end 35. This correlation law is dependent on the melting system 1 used, because it is dependent in particular on the melting furnace 10, the suction hood 30 and the dilution rate of the combustion fumes F in the free air prior to their capture by the suction hood 30.

According to an embodiment, the mean volatile organic compound concentration measured at the filtration end 35 by a volatile organic compound sensor, is measured downstream from the dust filter 39, i.e., after the dust filter 39 has filtered the combustion fumes F.

For example, the time interval corresponds to a melting cycle, which corresponds to the time interval elapsing between the introduction of the first quantity of aluminum scrap, and the step of draining the liquid aluminum M. During this melting cycle, a mean carbon monoxide concentration value Cm is measured by calculating an arithmetic mean of the carbon monoxide concentration values C measured by the carbon monoxide sensor 37 over said melting cycle. Over the same melting cycle, a mean VOC concentration value [VOC]ₘ is measured by calculating an arithmetic mean of the VOC concentration values [VOC] measured by the VOC sensor.

This mean VOC concentration value [VOC]m is then associated with the mean carbon monoxide concentration value Cm. This operation is repeated at least three times to obtain at least three pairs of mean carbon monoxide Cm and VOC concentration values [VOC]m, making it possible to establish a linear equation in the form [COV]ₘ=α×Cm , where [VOC]ₘ is the mean VOC concentration measured over a cycle expressed in milligrams of carbon equivalent per normal cubic meter (mg/Nm³), Cm is the mean carbon monoxide concentration measured over a cycle expressed in ppm, and α is a positive real coefficient. For example, the coefficient a determined in this case is equal to 0.4.

It is then possible to determine a restart threshold value Sr, a first threshold S1, a second threshold S2, and a third threshold S3 following the calibration step E11, which form the piloting parameters which can be used in the piloting step E6. Said thresholds are determined to limit the volatile organic compound emissions VOC lower than defined thresholds, for example by use, or by normative requirements.

For example, the first threshold S1 can correspond to the following formula:

$$S 1 = {\frac{2}{5 α} [ VOC ]}_{max}$$

the second threshold S2 can correspond to the following formula:

$$S 2 = {\frac{2}{α} [ VOC ]}_{max}$$

the third threshold S3 can correspond to the following formula:

$$S 3 = {\frac{4}{α} [ VOC ]}_{max}$$

the restart threshold value Sr can correspond to the following formula:

$$Sr = {\frac{3}{5 α} [ VOC ]}_{max}$$

where α is the coefficient determined by establishing the linear equation described above, and
where [VOC]ₘₐₓ is a maximum mean VOC concentration value over a cycle, fixed arbitrarily by the user, or by regulatory or normative requirements.

Although such values are not restrictive, fixing such thresholds by the correlation law, according to the maximum mean VOC concentration value over a cycle, fixed arbitrarily by the user, or by regulatory or normative requirements makes it possible to ensure that the VOC emissions will remain on average over a melting cycle contained at concentrations lower than a safety value and will be less than the regulatory thresholds.

The melting process then comprises a first introduction step E21 wherein a first quantity of said aluminum scrap is introduced into the melting chamber 13 of the melting furnace 10. The first introduction step E21 can also comprise the introduction of at least one salt with the aluminum scrap. Thus, during the melting step which will be described hereinafter, it is possible to obtain a slag L covering the liquid aluminum M and comprising alumina and said at least one salt. Advantageously, the introduction of at least one salt during the first introduction step E21 makes it possible to trap solid residual organic compounds (aromatic polycyclic hydrocarbons, soot, etc.) which are obtained from the thermolysis of the organic materials present in the aluminum scrap. This slag L also has the advantage of forming a protective layer against oxidation which is particularly useful during all the steps of the melting process, and in particular during the piloting step E6.

Once the raw materials required for melting have been introduced into the furnace, the melting process comprises a melting step E3 wherein the firing device 21 is fired so that the burner 20 supplies heat in the melting chamber 13 of the melting furnace 10 when it is supplied with oxidant and fuel respectively by the oxidant injector 23, and by the fuel injector 25. This melting step E3 thus results in the formation by melting of liquid aluminum M, and in the formation of combustion fumes F, but also of the slag L if a salt has been introduced into the melting chamber 13.

The melting process generally comprises a cooling step E4, wherein the combustion fumes F are diluted and cooled in the free air outside the melting chamber 13. As seen in FIG. 1, the cooling step E4 can comprise an evacuation step wherein the evacuation means 17 are actuated to allow the evacuation of the combustion fumes F produced during the melting step E3 outside the melting chamber 13 and in the free air. Then, a suction step can be implemented, wherein the suction hood 30 captures by suction the combustion fumes F present in the free air outside the melting furnace 10. The arrangements described above make it possible to cool the combustion fumes F outside the melting chamber 13 in the free air. This cooling step E4 is particularly advantageous because it makes it possible to dilute and cool the combustion fumes F while minimizing toxic dioxin formation.

Once the combustion fumes F are captured by the suction hood 30, the melting process comprises the measurement step E5 wherein the carbon monoxide sensor 37 measures the value of the carbon monoxide concentration C in the combustion fumes F. This measurement step E5 makes it possible to determine in real time the carbon monoxide concentration C in the combustion fumes F, rapidly after these combustion fumes F have been formed. This is particularly advantageous, because it makes it possible to ascertain very quickly the VOC concentration in the combustion fumes F, when referring to the formula established during the calibration step E11 for example. It is clearly understood that over a melting cycle, the cooling step E4, and the measurement step E5 can be implemented simultaneously and continuously.

The melting process also comprises the piloting step E6 wherein the control device 50 receives an item of input information representative of the value of the carbon monoxide concentration C measured by the carbon monoxide sensor 37, and pilots the oxidant flow injected by the oxidant injector 23 and/or pilots the fuel flow injected by the fuel injector 25, according to said item of input information, the oxidant and fuel flows being piloted to contain the VOC content at the output of the melting furnace at concentrations less than a safety value. The term “pilot” means that the control device 50 is capable of controlling or varying the oxidant and/or fuel flows introduced into the furnace chamber, for example via one or more valves.

In particular, and as detailed in the non-restrictive embodiment of FIG. 2, during the piloting step E6, the control device 50 pilots the oxidant flow injected by the oxidant injector 23, and/or the fuel flow injected by the fuel injector 25 according to the following operating modes.

A first operating mode Mod1 comprises choosing the oxidant flow and the fuel flow to introduce the oxidant and the fuel into the melting chamber 13 in stoichiometric proportions. This first operating mode Mod1 is established if the value of the carbon monoxide concentration C is strictly less than the first threshold S1, for example as determined during the calibration step E11. According to an embodiment, the first threshold S1 is substantially equal to 25 ppm, 30 ppm, 35 ppm or 40 ppm. Optionally, the first operating mode Mod1 can also comprise the implementation of a second introduction step E22 wherein a second quantity of aluminum scrap is introduced into the melting chamber 13 of the melting furnace 10. For example, it can be provided that the second introduction step E22 be implemented when the control device 50 pilots the oxidant flow and the fuel flow in the first operating mode directly after having piloted the oxidant flow and the fuel flow in an operating mode chosen from a second, a third, or a fourth operating mode which are described hereinafter. Thus, it is possible to adapt the quantity of aluminum scrap introduced into the melting chamber 13, without previously measuring the quantity of volatile organic compounds VOC in the aluminum scrap. The liquid aluminum M melting yield is thus increased.

A second operating mode comprises varying a ratio between the oxidant flow and the fuel flow. This ratio is varied between an initial ratio corresponding to an introduction of the oxidant and the fuel under stoichiometric conditions into the melting chamber 13, and a maximum ratio corresponding to a zero fuel flow value introduced into the melting chamber 13 and a maximum oxidant flow value introduced into the melting chamber 13 by the oxidant injector 23, said ratio between the oxidant flow and the fuel flow being varied according to the value of the carbon monoxide concentration C measured by the carbon monoxide sensor 37. It is therefore clearly understood that in the second operating mode Mod2, the oxidant is still introduced either under stoichiometric conditions with respect to the fuel, or in excess. For this, it is possible either to increase the oxidant flow introduced into the melting chamber 13 by the oxidant injector 23, or to lower the fuel flow introduced into the melting chamber 13 by the fuel injector 25, or both. The variation of the ratio between the fuel flow and the oxidant flow introduced into the melting chamber 13 can be proportional to the carbon monoxide concentration C, or linked with the carbon monoxide concentration by an exponential relationship or any other relationship determined by a person skilled in the art, for example experimentally. This second operating mode Mod2 is established if the value of the carbon monoxide concentration C is strictly less than a second threshold S2 and greater than or equal to the first threshold S1. Thus, the first threshold S1 is strictly less than the second threshold S2. According to an embodiment, the second threshold S2 is substantially equal to 125 ppm, 150 ppm, 175 ppm, or 200 ppm. More generally, the second threshold S2 can be substantially equal to five times the value of the first threshold S1. The term “substantially equal” means within more or less 10%.

A third operating mode Mod3 comprises placing the oxidant flow at the maximum oxidant flow value, stopping the fuel flow, and switching off the firing device 21. This third operating mode Mod3 is established if the value of the carbon monoxide concentration C is strictly less than a third threshold S3 and greater than or equal to the second threshold S2. Thus, the second threshold S2 is strictly less than the third threshold S3. According to an embodiment, the third threshold S3 is substantially equal to 250 ppm, 300 ppm, 350 ppm, or 400 ppm. More generally, the third threshold S3 can be substantially equal to two times the value of the second threshold S2.

Given that the first operating mode Mod3 comprises switching off the firing device, it is sometimes necessary to restart the melting step E3 once the carbon monoxide concentration C measured has passed below a certain threshold, and thus save time on the melting of the aluminum scrap. Thus, if the firing device 21 is switched off, and if the value of the carbon monoxide concentration C is strictly less than a restart threshold value Sr, then the firing device 21 is switched on. The restart threshold value Sr is generally strictly greater than the first threshold S1 and strictly less than the second threshold S2. According to an embodiment, the restart threshold value Sr is substantially equal to 37.5 ppm, 45 ppm, 52.5 ppm, or 60 ppm. More generally, the restart threshold value Sr is substantially equal to 1.5 times the value of the first threshold S1. Advantageously, refiring the firing device 21 once the carbon monoxide concentration C is less than a sufficiently low threshold makes it possible to restart melting of the aluminum, and limit oxide formation on the surface of the liquid aluminum M. This arrangement makes it possible to account for any hysteresis phenomena during the melting of the metal and the combustion of the organic coatings, which are linked with the inertia of the melting furnace 10.

Finally, a fourth operating mode Mod4 comprises placing the oxidant flow at a maximum flow value, stopping the fuel flow, and switching off the firing device 21 if it was not previously switched off. This fourth operating mode Mod4 is established if the value of the carbon monoxide concentration C is strictly greater than the third threshold S3. Advantageously, if the melting furnace 10 is a rotary furnace comprising a rotary drum 11, the fourth operating mode Mod4 also comprises the variation and in particular the reduction of the rotational speed of the rotary drum 11. Moreover, if the melting furnace 10 comprises an additional oxidant lance 27, then the fourth operating mode Mod4 also comprises the introduction of an additional fuel flow inside the melting chamber 13 by the additional lance 27. In this way, it is possible to increase the quantity of oxidant introduced into the melting chamber 13, and destroy by combustion a greater quantity of volatile organic compounds VOC without lowering the melting temperature of the melting furnace 10.

The piloting of the oxidant and fuel injectors 23, 25 makes it possible both to limit the formation of volatile organic compounds VOC, but also to prevent overoxidation risks. Indeed, if the oxidant and fuel injectors 23, 25 are placed in the second, third and fourth operating mode Mod2, Mod3, and Mod4 therefore in oxidation stoichiometry for gas injection, the excess oxidant is consumed to limit the formation of volatile organic compounds VOC, and does not oxidize the liquid aluminum M. Moreover, and advantageously, if the melting process comprises the introduction of at least one salt, the slag L formed acts as a screen against the oxidation of the liquid aluminum M by the injected oxidant.

It is clearly understood that the steps of the melting process described hereinabove can be repeated, or implemented continuously throughout the melting of the aluminum scrap. In particular, the piloting step E6 is carried out after the measurement step E5 within the same phase and this phase can be repeated over time, in particular cyclically, periodically or continuously. For example, the measurement step E5 is implemented several times over a piloting time interval, so as to implement the piloting step E6 several times over said piloting time interval. In the same way, the measurement step E5 and the piloting step E6 are implemented simultaneously and/or continuously and in real time over the piloting interval. Thus, it is possible to pilot the melting furnace 10 in real time during the piloting process. In this way, it is possible to optimize the melting time of the quantity of aluminum scrap, while limiting the quantity of volatile organic compounds VOC evacuated outside the melting chamber 13.

All of the arrangements described above make it possible to provide a melting process making it possible both to form liquid aluminum M from aluminum scrap and limit the quantity of volatile organic compounds in the combustion fumes F evacuated outside the melting chamber 13 of the melting furnace 10 by the thermolysis of said volatile organic compounds in-situ in the melting furnace 10.

1. An aluminum scrap melting system (1) for melting aluminum scrap, the melting system (1) comprising:
a melting furnace (10) intended to melt said aluminum scrap, and comprising:
a drum (11) internally delimiting a melting chamber (13) intended to receive said aluminum scrap to be melted;
a burner (20) comprising a firing device (21), at least one oxidant injector (23), and at least one fuel injector (25), said oxidant injector (23) being configured to inject an oxidant flow inside the melting chamber (13), said fuel injector (25) being configured to inject a fuel flow inside the melting chamber (13), and the firing device (21) being configured to start a combustion of the oxidant and the fuel injected into the melting chamber (13), to supply heat into the melting chamber (13);
evacuation means (17) configured to make it possible to extract all or some of the combustion fumes (F) from inside the melting chamber (13) to a vent zone located outside the melting chamber (13) and where air is free to circulate;
a suction hood (30) disposed outside the melting chamber (13) and intended to capture by suction all or some of said combustion fumes (F) present in the vent zone, said suction hood (30) furthermore comprising an inspection pipe (31) comprising a carbon monoxide sensor (37) configured to measure a value of a carbon monoxide concentration (C) in said combustion fumes (F) captured by the suction hood (30), the carbon monoxide sensor comprising a laser emitter configured to emit a laser radiation, and a laser receiver configured to receive said emitted laser radiation, and to measure an absorption spectrum of said received laser radiation, the value of the carbon monoxide concentration (C) being determined on the basis of said absorption spectrum thus measured;
a control device (50) configured to receive an item of input information representative of the value of the carbon monoxide concentration (C) measured by the carbon monoxide sensor (37), and to pilot said oxidant flow injected by said oxidant injector (23) and/or said fuel flow injected by said fuel injector (25), according to said item of input information, the oxidant and fuel flows being piloted to contain the volatile organic compound content (VOC) at the output of the melting furnace at concentrations less than a safety value.

2. The system (1) according to claim 1, wherein the melting furnace (10) is a rotary furnace comprising a rotary drum (11) configured to be rotated.

3. The system (1) according to claim 1, wherein the evacuation means (17) of the melting furnace (10) comprise at least one opening formed in a wall of the melting furnace (10).

4. The system (1) according to claim 1, wherein the melting furnace (10) comprises an additional oxidant lance (27) distinct from the at least one oxidant injector (23), and configured to allow the introduction of an additional oxidant flow inside the melting chamber (13).

5. The system (1) according to claim 1, wherein the oxidant injector (23) is an industrially pure oxygen injector.

6. The system (1) according to claim 1, wherein the inspection pipe (31) of the suction hood (30) comprises a suction end (33) at which the combustion fumes (F) are captured, and a filtration end (35), opposite the suction end (33), said filtration end (35) being equipped with a dust filter (39) configured to filter residue remaining in the combustion fumes (F), at the filtration end (35).

7. A process for melting aluminum scrap by an aluminum scrap melting system (1), the melting process comprising:
a step (E1) of providing an aluminum scrap melting system (1) according to claim 1;
a first introduction step (E21) wherein a first quantity of said aluminum scrap is introduced into the melting chamber (13) of the melting furnace (10);
a melting step (E3) wherein the firing device (21) is fired so that the burner (20) supplies heat into the melting chamber (13) of the melting furnace (10) when it is supplied with oxidant and with fuel respectively by the oxidant injector (23), and by the fuel injector (25), said melting step (E3) resulting in the formation of liquid aluminum (M) by melting, and in the formation of combustion fumes (F);
a measurement step (E5) wherein the carbon monoxide sensor (37) measures the value of the carbon monoxide concentration (C) in the combustion fumes (F) captured by the suction hood (30);
a piloting step (E6) wherein the control device (50) receives an item of input information representative of the value of the carbon monoxide concentration (C) measured by the carbon monoxide sensor (37), and pilots the oxidant flow injected by the oxidant injector (23) and/or pilots the fuel flow injected by the fuel injector (25), according to said item of input information, wherein the oxidant and fuel flows are piloted to contain the volatile organic compound content (VOC) at the output of the melting furnace at concentrations less than a safety value,
the process furthermore comprising a prior calibration step (E11), wherein a correlation law is established between:
a mean carbon monoxide concentration (Cm) measured by the carbon monoxide sensor (37), and
a mean volatile organic compound concentration (VOC) measured at the filtration end (35) by a volatile organic compound sensor (VOC),
said correlation law being established on the basis of at least three mean carbon monoxide concentration values (Cm) measured by the carbon monoxide sensor (37), each associated with a mean volatile organic compound concentration value ([VOC]ₘ) measured over the same time interval.

8. The process according to claim 7, wherein the first introduction step (E21) furthermore comprises the introduction of at least one salt, so as to obtain a slag (L) covering the liquid aluminum (M) and comprising alumina and said at least one salt during the melting step (E3).

9. The process according to claim 7, wherein, during the piloting step (E6), the control device (50) pilots the oxidant flow injected by the oxidant injector (23), and/or the fuel flow injected by the fuel injector (25) according to the following operating modes:
a first operating mode (Mod1) wherein the oxidant flow and the fuel flow are chosen to introduce the oxidant and the fuel into the melting chamber (13) in stoichiometric proportions, the first operating mode (Mod1) being established if the value of the carbon monoxide concentration (C) is strictly less than a first threshold (S1);
a second operating mode (Mod2) wherein a ratio between the oxidant flow and the fuel flow is varied between an initial ratio corresponding to an introduction under stoichiometric conditions of oxidant and fuel into the melting chamber (13) respectively by the oxidant injector (23) and the fuel injector (25), and a maximum ratio corresponding to a zero fuel flow introduced by the fuel injector (25) into the melting chamber (13), and a maximum oxidant flow introduced by the oxidant injector (23) into the melting chamber (13), said ratio between the oxidant flow and the fuel flow being varied according to the value of the carbon monoxide concentration (C) measured, the second operating mode (Mod2) being established if the value of the carbon monoxide concentration (C) is strictly less than a second threshold (S2) and greater than or equal to the first threshold (S1);
a third operating mode (Mod3) wherein the oxidant flow is placed at the maximum oxidant flow value, the fuel flow is stopped, and the firing device (21) is switched off, the third operating mode (Mod3) being established if the value of the carbon monoxide concentration (C) is strictly less than a third threshold (S3) and greater than or equal to the second threshold (S2);
a fourth operating mode (Mod4) wherein the oxidant flow is placed at a maximum oxidant flow value, the fuel flow is stopped, the firing device (21) is switched off, the fourth operating mode (Mod4) being established if the value of the carbon monoxide concentration (C) is strictly greater than the third threshold (S3),
said thresholds being determined to limit the volatile organic compound emissions (VOC) lower than defined thresholds.

10. The process according to claim 9, wherein, in the step (E1), the oxidant injector (23) is an industrially pure oxygen injector, and wherein the fourth operating mode (Mod4) furthermore comprises introducing an additional oxidant flow inside the melting chamber (13) by the additional lance (27).

11. The process according to claim 9, wherein the first operating mode (Mod1) comprises the implementation of a second introduction step (E22) wherein a second quantity of aluminum scrap is introduced into the melting chamber (13) of the melting furnace (10).

12. The process according to claim 9, wherein during the piloting step (E6), if the firing device (21) is switched off, and if the value of the carbon monoxide concentration (C) is strictly less than a restart threshold value (Sr), then the firing device (21) is switched on, the restart threshold value (Sr) being strictly greater than the first threshold (S1) and strictly less than the second threshold (S2).

13. The process according to claim 7, further comprising a cooling step (E4), wherein the combustion fumes (F) are diluted and cooled in the free air outside the melting chamber (13).

14. The process according to claim 7, wherein the piloting step (E6) is carried out after the measurement step (E5) within the same phase and said phase is repeated over time, in particular cyclically or periodically.
